(19) United States
(12) Patent Application Publication
(10) Pub. No.: US 2025/0067935 A1
(43) Pub. Date: Feb. 27, 2025

(54) VARIABLE REFLECTIVE PACKAGE

(71) Applicant: Lumentum Operations LLC, San Jose, CA (US)

(72) Inventors: Richard D. FAULHABER, San Carlos, CA (US); Michael LOVELADY, Mountain View, CA (US); Titus WHITEHEAD, Sunnyvale, CA (US); Peter BULLEN, San Jose, CA (US); Kaitlyn COMSTOCK, San Jose, CA (US); Ramunas WIERZBICKI, San Jose, CA (US)

(21) Appl. No.: 18/635,493

(22) Filed: Apr. 15, 2024

Related U.S. Application Data
(60) Provisional application No. 63/578,046, filed on Aug. 22, 2023.

(51) Int. Cl. G02B 6/26

(52) U.S. Cl. CPC G02B 6/264

(57) ABSTRACT

In some implementations, an optical component includes an optical fiber having a core for guiding signal light and a cladding surrounding the core. A cladding light stripper may be defined for the optical fiber, where the cladding light stripper has a length along the cladding. The optical component may include a package, retaining the cladding light stripper, having a surface that faces the cladding light stripper. A light reflectivity of the surface may vary, by surface location, to control a degree of light absorption along the package.

### CROSS-REFERENCE TO RELATED APPLICATION

This Patent Application claims priority to U.S. Provisional Patent Application No. 63/578,046, filed on Aug. 22, 2023, and entitled “VARIABLE REFLECTIVE PACKAGE FOR HIGH POWER LASER COMPONENTS.” The disclosure of the prior Application is considered part of and is incorporated by reference into this Patent Application.

### TECHNICAL FIELD

The present disclosure relates generally to lasers and to a variable reflective package.

### BACKGROUND

A fiber laser is a laser in which an active gain medium is an optical fiber doped with an element capable of providing gain, such as erbium, ytterbium, neodymium, dysprosium, praseodymium, thulium, holmium, bismuth, or the like. A high-power fiber laser is a fiber laser that is capable of delivering a relatively high output power. For example, the output power of a high-power fiber laser may be in a range from tens of watts to several kilowatts.

### SUMMARY

In some implementations, an optical component includes an optical fiber having a core for guiding signal light and a cladding surrounding the core. A cladding light stripper may be defined for the optical fiber, where the cladding light stripper has a length along the cladding. The optical component may include a package, retaining the cladding light stripper, having a surface that faces the cladding light stripper. A light reflectivity of the surface may vary, by surface location, to control a degree of light absorption along the package.

In some implementations, an optical component includes an optical fiber having a core for guiding signal light and a cladding surrounding the core. A cladding light stripper may be defined for the optical fiber, where the cladding light stripper has a length along the cladding. The optical component may include a package, retaining the cladding light stripper, having a surface that faces the cladding light stripper. A light reflectivity of the surface may vary, by surface location, to reduce variations in a degree of light absorption along the package.

In some implementations, a package for an optical fiber includes a first surface having a light reflectivity that varies, by surface location, to control a degree of light absorption along the package. The package may include a second surface configured to absorb light in the package.

### BRIEF DESCRIPTION OF THE DRAWINGS

FIG. 1 is a side sectional view of an example optical component.

FIG. 2 is a top view of an optical fiber and a surface of a package of an optical component.

FIG. 3 is a top view of an optical fiber and a surface of a package of an optical component.

FIG. 4 is a side sectional view of an optical component.

### DETAILED DESCRIPTION

The following detailed description of example implementations refers to the accompanying drawings. The same reference numbers in different drawings may identify the same or similar elements.

Fiber lasers are a class of lasers that provide significant advantages of efficiency and practicality in comparison with other laser types such as free-space lasers. In fiber lasers, light is guided by an active fiber core typically doped with ions of a rare-earth element, such as ytterbium or erbium, which provides optical gain. The guiding property of the doped fiber core considerably relaxes requirements of optical alignment, and allows increases to the length of the gain medium to tens and even hundreds of meters, resulting in very high achievable optical gains. For example, using double-clad fiber (DCF), fiber lasers can be scaled to kilowatt (kW) power levels.

In fiber lasers, the gain medium can be pumped using an emission of one or more diode lasers. For example, in a DCF, pump light may propagate in an inner cladding surrounding the fiber core, and laser light may propagate in the fiber core. The inner cladding guides the pump light to be absorbed in the doped core for laser light amplification along the entire fiber length. Ideally, at an output of the fiber laser, no light will be propagating in the inner cladding, and all of the output laser beam will originate from the core. In some fiber laser systems, it is similarly desirable to have exclusively core light propagating between components or between amplification stages.

However, in practice, the output of a fiber laser can include some core light and some cladding light. The cladding light may contain residual unabsorbed pump light and any laser light that has escaped from the core into the cladding due to scattering or spontaneous emission in the core. The cladding light may contain optical beams at a large range of divergence angles. The cladding light can be deleterious for a number of applications, and should preferably be removed, or stripped, from the fiber.

A cladding light stripper may use a thin layer of a high index polymer applied to the cladding, may use notches or grooves in an outer surface of the cladding, or another suitable technique to strip the cladding light. The stripped cladding light may be scattered in a package associated with the cladding light stripper, absorbed, and converted to heat. Generally, the package may have consistent light reflectivity and/or light absorption characteristics, such that a scattering of the stripped cladding light is not controlled or uniform. Moreover, light escaping the cladding may have a greater intensity at some regions of the cladding light stripper and a lesser intensity at other regions of the cladding light stripper. Absorption of the greater intensity light may produce excessive heat, which can damage fiber coatings and other components, such as ferrules, splice protectors, or the like.

Some implementations described herein provide an optical component including a package configured to provide variable reflectivity and/or variable absorption of scattered light in the package. For example, the variable reflectivity and/or the variable absorption may be configured to direct the scattered light in a desired manner in order to control a degree of light absorption along the package. In this way, scattered light in the package can be absorbed more uniformly to provide improved thermal management of the scattered light.

In some implementations, the optical component may include an optical fiber configured as a fiber laser, a fiber amplifier, or the like. A cladding light stripper may be defined along a cladding of the optical fiber, thereby scattering light from the optical fiber. The package may retain the classing light stripper, and thus light escaping from the optical fiber due to the cladding light stripper may be scattered in the package.

The package may include a surface that faces the cladding light stripper. In some implementations, the surface may be configured with a light reflectivity that varies, by surface location, to control a degree of light absorption along the package. For example, different locations on the surface may have different light reflectivities. In some implementations, the light reflectivity of the surface of the package may be varied through texturing of the surface, such as pits, bumps, lines, cross-hatching, or other perturbations of the surface. In some implementations, the light reflectivity of the surface of the package may be varied by manipulating a material finish of the surface, such as by changing a material composition of the material finish. The material finish of the surface may include a plurality of material spots and/or a series of material strips. In some implementations, the material finish of the surface may include a continuously changing material composition (e.g., having smooth transitions between changes in the material composition). In some implementations, a material composition of the package itself may be varied to vary the light reflectivity of the surface of the package.

In some implementations, variations in the light reflectivity may be configured to direct the scattered light from regions of the package with high optical intensity to be absorbed at regions of the package where cooling is most effective. For example, at regions of the package associated with higher-intensity scattered light, the surface can be configured with a greater light reflectivity. Continuing with the example, at regions of the package associated with lower-intensity scattered light, the surface can be configured with a lesser light reflectivity. In this way, the scattered light may be directed in the package more uniformly, thereby improving the uniformity of light absorption in the package. Accordingly, the package may have improved thermal properties.

The package may include an additional surface that faces the cladding light stripper and faces the surface. The additional surface may be configured to absorb scattered light in the package (e.g., that is reflected from the surface). The additional surface may have a light absorption that is constant and/or may be configured with a light absorption that varies (e.g., gradually) by surface location, in a similar manner as described above. By varying the light absorption of the additional surface, additional control over the degree of light absorption along the package can be achieved.

In some implementations, the optical component may include a heat exchanger and/or a sensor (e.g., a photodetector). By uniformly distributing scattered light in the package using the variable light reflectivity of the surface, a location of the heat exchanger and/or of the sensor on the package can be more flexible and is not dictated solely by the pattern of light scattering produced by the cladding light stripper. Accordingly, the optical component may be free of placement constraints generally associated with the heat exchanger and/or the sensor.

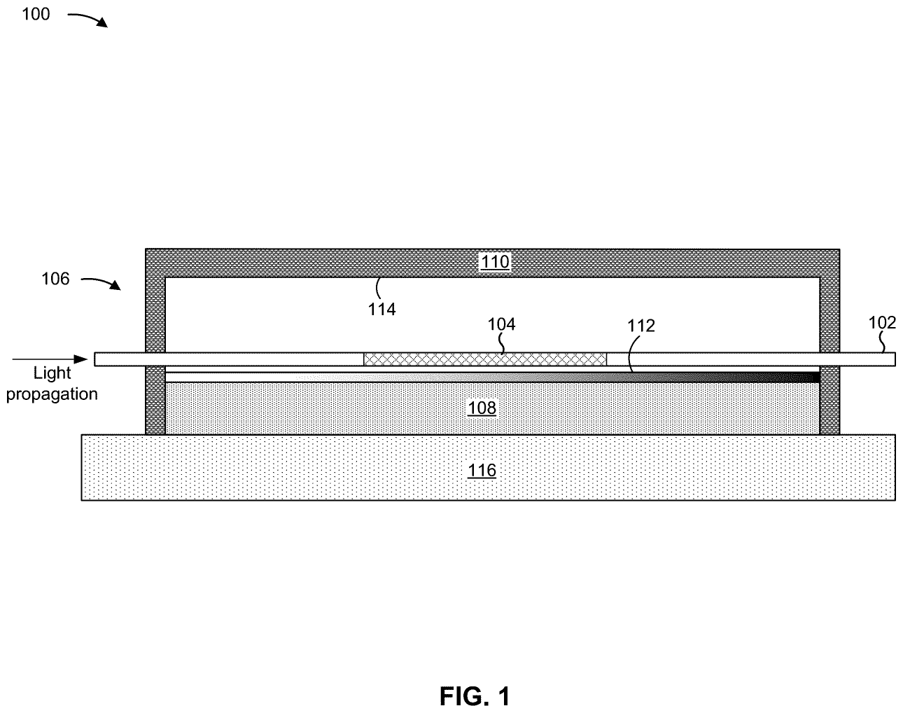

FIG. 1 is a side sectional view of an example optical component 100. The optical component 100 may be used in an optical system. For example, the optical component 100 may be a component of a fiber laser system, a fiber amplifier system, or the like.

The optical component 100 may include an optical fiber 102. The optical fiber 102 may include a core for guiding signal light, and a cladding surrounding the core. The optical fiber 102 may be a single-clad fiber or a DCF. The optical fiber 102 may be configured to provide optical gain. For example, the optical fiber 102 may be configured as a fiber laser, a fiber amplifier, or the like. As an example, the core of the optical fiber may be doped with ions of a rare-earth element, such as ytterbium or erbium.

The optical fiber 102 may include a section configured to allow light to escape from the optical fiber 102 (e.g., that scatters light escaping from the optical fiber 102). For example, at the section of the optical fiber 102, a cover (e.g., a coating, a buffer, or the like) of the optical fiber 102 may be removed to expose the cladding of the optical fiber 102. In some implementations, the section of the optical fiber 102 may be associated with a cladding light stripper 104 (also referred to as a “cladding mode stripper”). For example, a cladding light stripper 104 may be defined for the optical fiber 102, and the cladding light stripper 104 has a length along the cladding. The cladding light stripper 104 may be defined by perturbations in the cladding of the optical fiber 102, such as notches, grooves, etches, or the like, that are configured to cause light to escape from the cladding. The perturbations in the cladding may be uniformly distributed or chirped (e.g., increasing in frequency in a direction of light propagation through the optical fiber 102). Additionally, or alternatively, the cladding light stripper 104 may be defined by a material (e.g., a polymer) applied to the cladding of the optical fiber 102, where the material has a different (e.g., higher) refractive index than a refractive index of the cladding to cause light to escape from the cladding. In some implementations, other techniques than those described above can be used to define the cladding light stripper 104.

The optical component 100 may include a package 106 that includes a package base 108 and a package cover 110. The package base 108 may include a substrate, a block, or another carrier for the optical fiber 102. For example, the package base 108 may include a groove that extends across a length of the package base 108, and the optical fiber 102 may be disposed in the groove (e.g., such that at least the cladding light stripper 104 of the optical fiber 102 is disposed in the groove). As an example, the groove may be filled with a material, such as a polymer, that attaches the optical fiber 102 to the package base 108. Accordingly, the optical fiber 102 may be slightly raised with respect to the package base 108. The package cover 110 may enclose at least the cladding light stripper 104 of the optical fiber 102 and the package base 108. For example, the package cover 110 may include a top wall of the package 106 and/or one or more sidewalls of the package 106. Thus, the package 106 may retain at least the cladding light stripper 104 of the optical fiber 102.

Light from the optical fiber 102 may be scattered in the package 106. For example, the cladding light stripper 104 may cause light to scatter in the package 106. A light scattering rate from the cladding light stripper 104 may vary along the length of the cladding light stripper 104. The package 106 may be configured to provide variable reflectivity and/or variable absorption of the scattered light in the package 106, as described herein. For example, the variable reflectivity and/or the variable absorption may be configured to direct the scattered light in a desired manner in order to control and/or reduce variations in a degree of light absorption along the package 106. In this way, scattered light in the package 106 can be absorbed more uniformly to provide improved thermal management of the scattered light.

The package 106 may include a surface 112 (e.g., a surface layer) that faces at least the cladding light stripper 104 of the optical fiber 102. For example, the optical fiber 102 may be arranged with respect to the surface 112 such that light escaping from the cladding light stripper 104 is incident on the surface 112. The surface 112 may include a light-reflective material, such as gold, silver, or the like. In some implementations, a light reflectivity of the surface 112 (e.g., the surface 112 may be configured with a light reflectivity) varies, by surface location, to control and/or reduce variations in a degree of light absorption along the package 106 (e.g., a particular configuration of the light reflectivity controls and/or reduces variations in the light absorption in a particular manner). For example, different locations on the surface 112 may have different light reflectivities (e.g., that are intentional, rather than incidental or random due to surface imperfections). The light reflectivity may vary (e.g., according to a light reflectivity gradient) to direct the scattered light through the package 106 in a desired manner, thereby controlling and/or reducing variations in a degree of light absorption along the package 106. In some implementations, the light reflectivity of the surface 112 and/or the light scattering rate along the length of the cladding light stripper 104 may be selected to reduce variations in a degree of light absorption along the package 106 and/or to increase a uniformity of light absorption within the package 106.

In some implementations, the light reflectivity may vary in a direction parallel to an axis of the optical fiber 102. Additionally, or alternatively, the light reflectivity may vary in a direction perpendicular to the axis of the optical fiber 102. Variations in the light reflectivity may be present over an entirety of the surface 112, or may be confined to a region of the surface 112 (e.g., that encompasses less than the entirety of the surface 112). The surface 112 may have a light absorption that also varies in correlation with variations in the light reflectivity (e.g., as the light reflectivity increases, the light absorption decreases, and as the light reflectivity decreases, the light absorption increases).

In some implementations, a light reflectivity of the surface 112 varies gradually by surface location (e.g., the light reflectivity may steadily increase and/or steadily decrease along the surface 112). For example, the light reflectivity may steadily increase from a first end of the surface 112 to a second end of the surface 112, or the light reflectivity may steadily decrease from a first end of the surface 112 to a second end of the surface 112. As another example, the light reflectivity may steadily increase from a first end of the surface 112 to a point (e.g., a mid-point) between the first end and a second end of the surface 112, and the light reflectivity may steadily decrease from the point to the second end of the surface 112. As a further example, the light reflectivity may steadily decrease from a first end of the surface 112 to a point (e.g., a mid-point) between the first end and a second end of the surface 112, and the light reflectivity may steadily increase from the point to the second end of the surface 112. In some implementations, the light reflectivity may vary non-gradually.

In some implementations, variations in the light reflectivity may be configured to direct the scattered light from regions of the package 106 with high optical intensity to be absorbed at regions of the package 106 where cooling is most effective (e.g., a region of the package 106 associated with a greatest heat dissipation), thereby improving thermal management of the scattered light. In some implementations, with respect to the direction of light propagation through the optical fiber 102, variations in the light reflectivity may be configured to direct light escaping from a forward end of the cladding light stripper 104 toward a back end of the package 106. This configuration may provide improved uniformity of scattered light in the package 106 and/or improved thermal management of the scattered light, because light escaping from the cladding light stripper 104 may have a greatest intensity at the forward end of the cladding light stripper 104.

In some implementations, to vary the light reflectivity of the surface 112, the surface 112 may have a texturing. The texturing may be formed by chemical etching, laser engraving, embossing, knurling, additive manufacturing (e.g., utilizing powdered printing materials that can be textured by manipulating particle size and/or print parameters), or the like. The texturing may be formed prior to a reflective finish being applied to the surface 112, after the reflective finish is applied to the surface 112, or as part of the reflective finished being applied to the surface 112. The texturing may be in a configuration that defines the variations of the light reflectivity of the surface 112. For example, in a first region of the surface 112, the texturing may have a first configuration associated with a first light reflectivity; in a second region of the surface 112, the texturing may have a second configuration associated with a second light reflectivity; in a third region of the surface 112, the texturing may have a third configuration associated with a third light reflectivity, and so forth. The texturing may include pits in the surface 112, bumps on the surface 112, lines in the surface 112, cross-hatched lines in the surface 112, or other perturbations of the surface 112. As an example, where the texturing includes pits, the configuration of the pits may be manipulated, to thereby change light reflectivity, by changing a pitch between the pits, by changing a diameter of the pits, and/or by changing a depth of the pits. In some implementations, the configuration of the texturing may gradually change across the surface 112 (e.g., in steps or using smooth transitions) to gradually vary the light reflectivity of the surface 112.

In some implementations, a material finish of the surface 112 (e.g., a surface layer of the surface 112) may be used to vary the light reflectivity of the surface 112. In particular, the material finish may control variations in the light reflectivity of the surface 112 (e.g., a configuration of the material finish may define variations of the light reflectivity of the surface 112). The material finish of the surface 112 may be formed by plating, coating, additive manufacturing, or a similar technique for applying a material, such as a metal, to a substrate. The material finish may be manipulated, to thereby change light reflectivity, by changing a material composition of the material finish. Changing the material composition may include adding and/or eliminating one or more materials from the material finish, changing relative proportions of materials in the material finish, and/or changing a density of the material finish (e.g., a density at which the material finish is applied). In some implementations, the material finish may gradually change across the surface 112 (e.g., from a more reflective material finish to a less reflective material finish, or vice versa) to gradually vary the light reflectivity of the surface 112.

In some implementations, the material finish of the surface 112 may include a plurality of material spots (e.g., which can be circular or another shape) composed of one or more light-reflective materials. Accordingly, the material spots may be in a configuration that defines the variations of the light reflectivity of the surface 112. For example, in a first region of the surface 112, the material spots may have a first configuration associated with a first light reflectivity; in a second region of the surface 112, the material spots may have a second configuration associated with a second light reflectivity; in a third region of the surface 112, the material spots may have a third configuration associated with a third light reflectivity, and so forth. The configuration of the material spots may be manipulated, to thereby change the light reflectivity, by changing a pitch between the material spots, by changing a diameter of the material spots, and/or by changing a material composition of the material spots.

In some implementations, the material finish of the surface 112 may include a series of material strips, each composed of one or more light-reflective materials (e.g., each of the material strips may have a different material composition). Accordingly, a configuration of the material strips may define the variations of the light reflectivity of the surface 112. For example, a first material strip may have a first configuration associated with a first light reflectivity, a second material strip may have a second configuration associated with a second light reflectivity, a third material strip may have a third configuration associated with a third light reflectivity, and so forth. The configuration of the material strips may be manipulated, to thereby change the light reflectivity, by changing a width of the material strips and/or by changing a material composition of the material strips.

As an alternative to material strips, the material finish of the surface 112 may include a continuously changing material composition. Accordingly, a configuration of the continuously changing material composition may define the variations of the light reflectivity of the surface 112. As an example, the material finish of the surface 112 may have a feathering (e.g., smooth transitions) to produce the continuously changing material composition. In some implementations, to achieve the feathering, the material finish of the surface 112 may be applied from a first end to a second end of the surface 112 while a material composition of the material finish gradually changes during the application (e.g., by gradually changing a doping dose added to the material finish). In some implementations, to achieve the feathering, the material finish of the surface 112 may be applied, and then doped by implantation that sweeps from a first end to a second end of the surface 112 while the doping dose of the implantation gradually changes during the sweep. Additionally, or alternatively, the doping by implantation may be performed using a series of photoresists on the surface 112 configured to achieve a desired doping configuration. In some implementations, feathering can be achieved by applying a layer of a first material finish to the surface 112, removing a portion of the layer in a region of the surface 112, applying a layer of a second material finish in the region of the surface 112, smoothing the first material finish and the second material finish, and so forth using additional layers of material finish as needed.

In some implementations, a material composition of the package 106 itself may be used to vary the light reflectivity of the surface 112. In particular, a configuration of the material composition of the package 106 may define variations of the light reflectivity of the package 106, and by extension, of the surface 112 of the package 106. For example, the package 106 may include a multi-material gradient associated with varying light reflectivity. In one example, the multi-material gradient of the package 106 may be formed by additive manufacturing. For example, during forming of the package 106 by additive manufacturing, a material composition of the package 106 may be changed by changing a doping dose added to the material composition. Additionally, or alternatively, variations of the light reflectivity of the package 106 may be produced using mixing techniques, using sheet lamination, and/or by integrating components (e.g., of varying light reflectivity) into the package 106. In some implementations, a combination of two or more of the techniques described herein for varying the light reflectivity of the surface 112 may be employed.

The package 106 may include an additional surface 114 (e.g., a surface layer) that faces at least the cladding light stripper 104 of the optical fiber 102 and faces the surface 112. For example, the surface 114 may be arranged with respect to the optical fiber 102 and with respect to the surface 112 such that light escaping from the cladding light stripper 104 is incident on the surface 114 and/or light reflected from the surface 112 is incident on the surface 114. The surface 114 may be configured to absorb scattered light in the package 106. For example, the surface 114 may directly absorb the scattered light from the cladding light stripper 104 and/or may absorb reflections of the scattered light from the surface 112. The surface 114 may include a light-absorbing material, such as anodized aluminum or the like.

In some implementations, the surface 114 may have a light absorption that is constant across the surface 114 (e.g., the light absorption does not vary, except for negligible variations due to imperfections of the surface 114). In some implementations, a light absorption of the surface 114 (e.g., the surface 114 may be configured with a light absorption) varies (e.g., gradually) by surface location, which may be achieved in a similar manner as described above for varying the light reflectivity of the surface 112. By varying the light absorption of the surface 114, additional control over the degree of light absorption along the package 106 can be achieved.

In FIG. 1, the surface 112 is shown on the package base 108 and the surface 114 is shown on the package cover 110. In some implementations, the package cover 110 may include the surface 112 described herein and the package base 108 may include the surface 114 described herein.

The optical component 100 may include a heat exchanger 116. The heat exchanger 116 may be thermally coupled to the package 106. For example, one or more walls of the package cover 110 may attach to or otherwise contact the heat exchanger 116, and/or the package base 108 may be disposed on the heat exchanger 116. Light absorbed by the package 106 may be converted to heat that is transferred to the heat exchanger 116. The heat exchanger 116 may be configured to dissipate the heat. For example, the heat exchanger 116 may include a heat sink, a water block, or the like. By uniformly distributing scattered light in the package 106 using the variable light reflectivity of the surface 112, a location of the heat exchanger 116 on the package 106 is more flexible and is not dictated solely by (e.g., is unrelated to) the light scattering rate along the length of the cladding light stripper 104 (e.g., the pattern of light scattering produced by the cladding light stripper 104). For example, a location of the heat exchanger 116 on the package 106 may be unrelated to changes to an intensity of the scattered light along the length of the cladding light stripper 104.

By varying the light reflectivity of the surface 112 by surface location, a degree of light absorption along the package 106 can be controlled in a desired manner. For example, at regions of the package 106 associated with higher-intensity scattered light, the surface 112 can be configured with a greater light reflectivity. Continuing with the example, at regions of the package 106 associated with lower-intensity scattered light, the surface 112 can be configured with a lesser light reflectivity. In this way, the scattered light may be directed in the package 106 more uniformly, thereby improving the uniformity of light absorption in the package 106. Accordingly, the package 106 may have improved thermal properties.

As indicated above, FIG. 1 is provided as an example. Other examples may differ from what is described with regard to FIG. 1.

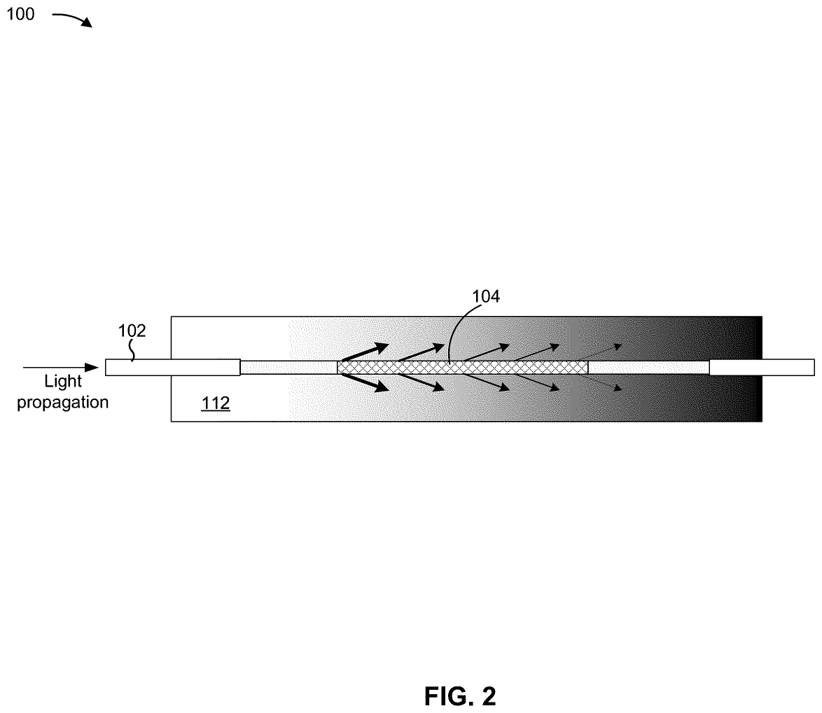

FIG. 2 is a top view of the optical fiber 102 and the surface 112 of the package 106 of the optical component 100. As shown, with respect to the direction of light propagation through the optical fiber 102, light escaping from the optical fiber 102 due to the cladding light stripper 104 may have a greatest intensity at a forward end of the cladding light stripper 104, and the light may gradually decrease in intensity along a length of the cladding light stripper 104 to a back end of the cladding light stripper 104. In FIG. 2, light intensity is represented by arrow thickness, where a thicker arrow represents a greater light intensity.

As further shown in FIG. 2, the light reflectivity of the surface 112 may vary in correlation with changes to an intensity of light escaping along a length of the cladding light stripper 104. For example, the light reflectivity of the surface 112 may vary in correlation with changes in the light scattering rate along the length of the cladding light stripper 104. As an example, where more light is scattered from the cladding light stripper 104, the light reflectivity of the surface 112 may be greater, and where less light is scattered from the cladding light stripper 104, the light reflectivity of the surface 112 may be lesser. For example, the light reflectivity of the surface 112 may gradually decrease (and the light absorption may gradually increase) from a first end of the surface 112 (e.g., which is associated with a high light reflectivity and a low light absorption) to a second end of the surface 112 (e.g., which is associated with a low light reflectivity and a high light absorption), thereby defining a light reflectivity gradient. The decrease in the light reflectivity and/or the increase in the light absorption may be proportional or non-proportional to the light scattering rate along the length of the cladding light stripper 104.

As indicated above, FIG. 2 is provided as an example. Other examples may differ from what is described with regard to FIG. 2.

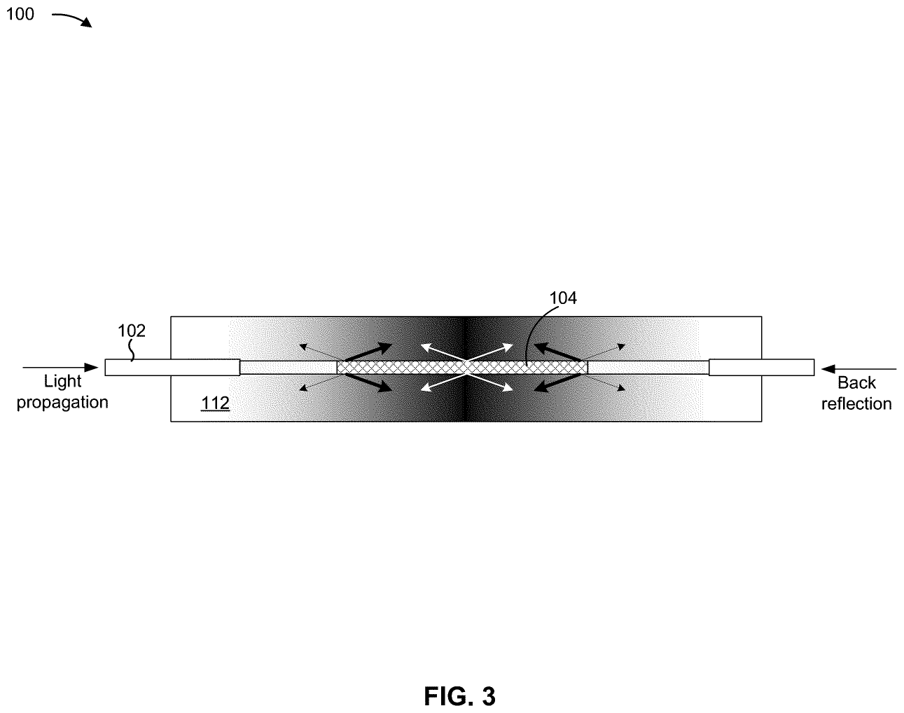

FIG. 3 is a top view of the optical fiber 102 and the surface 112 of the package 106 of the optical component 100. FIG. 3 shows an alternative configuration for the light reflectivity of the surface 112 from that shown in FIG. 2. FIG. 3 shows forward-propagating light through the optical fiber 102, similarly as described in connection with FIG. 2, as well as back-reflected light through the optical fiber 102 (e.g., that propagates in an opposite direction to a direction of the forward-propagating light). In a similar manner as the forward-propagating light, the back-reflected light escaping from the optical fiber 102 due to the cladding light stripper 104 may have a greatest intensity at the back end of the cladding light stripper 104, and the light may gradually decrease in intensity along the length of the cladding light stripper 104 to the forward end of the cladding light stripper 104.

Accordingly, as further shown in FIG. 3, the light reflectivity of the surface 112 may vary in correlation with changes of an intensity of the forward-propagating light, and changes of an intensity of the back-reflected light. For example, the light reflectivity of the surface 112 may gradually decrease (and the light absorption may gradually increase) from the first end of the surface 112 (e.g., which is associated with a high light reflectivity and a low light absorption) to a point between (e.g., approximately halfway between) the first end and the second end of the surface 112 (e.g., which is associated with a low light reflectivity and a high light absorption), and the light reflectivity of the surface 112 may gradually increase (and the light absorption may gradually decrease) from the point to the second end of the surface 112 (e.g., which is associated with a high light reflectivity and a low light absorption).

As indicated above, FIG. 3 is provided as an example. Other examples may differ from what is described with regard to FIG. 3.

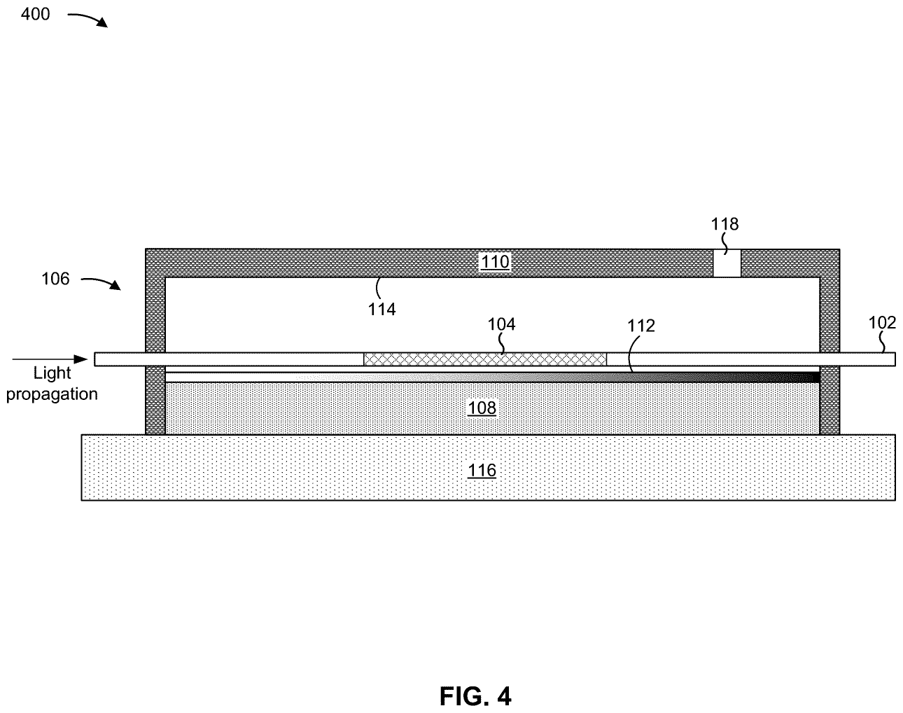

FIG. 4 is a side sectional view of the optical component 100. The optical component 100 may further include a sensor 118. The sensor 118 may be configured to detect a characteristic associated with the light that escapes from the optical fiber 102 due to the cladding light stripper 104 (e.g., the light scattered from the cladding light stripper 104 in the package 106). In some implementations, the sensor 118 may be a photodetector, such as a photodiode, a photoresistor, a phototransistor, or another photovoltaic cell. For example, the sensor 118 implemented as a photodiode may be configured as a power monitor, a stray light sensor, or the like. In some implementations, the sensor 118 may be a temperature sensor.

The sensor 118 may be disposed in the package 106 (e.g., in the package cover 110). For example, an active area of the sensor 118 may be exposed to an interior of the package 106, thereby facilitating sensing of conditions within the package 106. As described herein, by varying the light reflectivity of the surface 112 to control the light scattered by the cladding light stripper 104, the light can be distributed uniformly within the package 106, such that the sensor 118 is less sensitive to physical position in the package 106 and can obtain consistent measurements regardless of position in the package 106. Accordingly, a location of the sensor 118 on the package 106 is more flexible and is not dictated solely by (e.g., is unrelated to) the light scattering rate along the length of the cladding light stripper (e.g., the pattern of light scattering produced by the cladding light stripper 104). For example, a location of the sensor 118 in the package 106 may be unrelated to changes to an intensity of the scattered light along the length of the cladding light stripper 104. As an example, the sensor 118 may be located at a non-centralized location of the package 106, such as a location that is nearer to an edge of the package 106 than to a center of the package 106.

As indicated above, FIG. 4 is provided as an example. Other examples may differ from what is described with regard to FIG. 4.

While the description above is in terms of a cladding light stripper 104 retained in a package 106, in some implementations, techniques described herein may be used with a different component. For example, a housing may retain a terminated end or an endcap of an optical fiber (e.g., where light is scattered from an end of the optical fiber). Here, variations in the light reflectivity of the housing, as described herein, may be configured to direct scattered light from regions of the housing with high optical intensity to be absorbed at regions of the housing where cooling is most effective. By controlling the scattered light in the housing using variable light reflectivity, a location of a heat exchanger and/or a sensor on the housing can be more flexible and is not dictated solely by the pattern of light scattering produced by the terminated end or endcap, or by the incident ray location of forward-propagating light in the optical fiber.

As another example, a back-reflection barrier may employ a variable reflective surface, as described herein. For example, the variable light reflectivity, described herein, may be used in a device or in an application where back reflection of light is high (e.g., whether due to external work pieces, test setups, or internal features of an optical chain). As an example, a housing for an endcap, described above, may experience high back reflection of light. The back-reflection barrier may have variations in light reflectivity, as described herein, configured to guide light from areas of high optical intensity to be absorbed before being back reflected into an optical fiber. By controlling the back-reflected light using variable light reflectivity, a location of a heat exchanger and/or a sensor on a device can be more flexible and is not dictated solely by the first incident ray of back-reflected light.

As a further example, a beam dump may employ a variable reflective surface, as described herein. For example, an internal portion of the beam dump may have variable reflectivity (e.g., where optical intensity is high), as described herein. Here, variations in the light reflectivity of the beam dump, as described herein, may be configured to direct light from regions of the beam dump with high optical intensity to be absorbed at regions of the beam dump where cooling is most effective. By controlling the light using variable light reflectivity, a location of a heat exchanger and/or a sensor on the beam dump can be more flexible and is not dictated solely by the areas of the beam dump that experience the most direct illumination.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When a component or one or more components is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An optical component, comprising:
an optical fiber having a core for guiding signal light and a cladding surrounding the core;
a cladding light stripper defined for the optical fiber, the cladding light stripper having a length along the cladding,
wherein a light scattering rate from the cladding light stripper varies along the length; and
a package, retaining the cladding light stripper, having a surface that faces the cladding light stripper,
wherein a light reflectivity of the surface varies, by surface location, to control a degree of light absorption along the package.

2. The optical component of claim 1, wherein the light reflectivity of the surface varies in correlation with changes in the light scattering rate along the length of the cladding light stripper.

3. The optical component of claim 1, wherein the light reflectivity of the surface and the light scattering rate along the length of the cladding light stripper are selected to reduce variations in the degree of light absorption along the package.

4. The optical component of claim 1, further comprising:
a sensor disposed in the package,
wherein a location of the sensor in the package is unrelated to the light scattering rate along the length of the cladding light stripper.

5. The optical component of claim 1, further comprising:
a heat exchanger thermally coupled to the package,
wherein a location of the heat exchanger with respect to the package is unrelated to the light scattering rate along the length of the cladding light stripper.

6. The optical component of claim 1, wherein variations in the light reflectivity of the surface are defined by at least one of:
a texturing of the surface,
a material finish of the surface, or
a material composition of the package.

7. The optical component of claim 1, wherein:
a material finish of the surface controls variations in the light reflectivity of the surface,
the material finish includes a series of material strips, and
each of the material strips has a different material composition.

8. The optical component of claim 1, wherein a material finish of the surface controls variations in the light reflectivity of the surface, and the material finish has a feathering of a continuously changing material composition.

9. The optical component of claim 1, wherein the light reflectivity varies in a direction parallel to an axis of the optical fiber.

10. The optical component of claim 1, wherein the package has an additional surface that faces the surface, and
wherein a light absorption of the additional surface varies by surface location.

11. An optical component, comprising:
an optical fiber having a core for guiding signal light and a cladding surrounding the core;
a cladding light stripper defined for the optical fiber,
wherein the cladding light stripper has a length along the cladding; and
a package, retaining the cladding light stripper, having a surface that faces the cladding light stripper,
wherein a light reflectivity of the surface varies, by surface location, to reduce variations in a degree of light absorption along the package.

12. The optical component of claim 11, wherein the light reflectivity varies gradually in correlation with changes to an intensity of light that is to escape along the length of the cladding light stripper.

13. The optical component of claim 12, wherein the light reflectivity of the surface and the intensity of light that is to escape along the length of the cladding light stripper are selected to increase a uniformity of light absorption within the package.

14. The optical component of claim 11, further comprising:
a sensor disposed in the package,
wherein a location of the sensor in the package is unrelated to changes to an intensity of light that is to escape along the length of the cladding light stripper.

15. The optical component of claim 11, wherein the light reflectivity varies in a direction parallel to an axis of the optical fiber.

16. The optical component of claim 11, wherein the light reflectivity varies in a direction perpendicular to an axis of the optical fiber.

17. The optical component of claim 11, wherein at least one of:
the surface has a texturing that defines variations of the light reflectivity of the surface, or
a material finish of the surface defines variations of the light reflectivity of the surface.

18. A package for an optical fiber, comprising:
a first surface having a light reflectivity that varies, by surface location, to control a degree of light absorption along the package; and
a second surface configured to absorb light in the package.

19. The package of claim 18. wherein a light absorption of the second surface varies by surface location.

20. The package of claim 18, wherein variations of the light reflectivity of the first surface are defined by at least one of:
a texturing of the first surface.
a material finish of the first surface, or
a material composition of the package.
